(19) United States
(12) Patent Application Publication
(10) Pub. No.: US 2009/0124286 A1
(43) Pub. Date: May 14, 2009

(54) PORTABLE HANDS-FREE DEVICE WITH SENSOR

(75) Inventors: Johan Hellfalk, Akarp (SE); Markus Palmgren, Landskrona (SE); Henrik Af Petersens, Malmo (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/938,443

(22) Filed: Nov. 12, 2007

(51) Int. Cl. H04M 11/00

(52) U.S. Cl. 455/556.1

(57) ABSTRACT

A method may include detecting a stimulus based on a sensor of a peripheral device, determining an operative state of a main device, determining whether the operative state of the main device should be adjusted based on the stimulus, and adjusting at least one of the operative state of the main device or the peripheral device if the stimulus indicates a use of the peripheral device by a user.

### BACKGROUND

With the development of consumer devices, such as mobile phones and personal digital assistants (PDAs), users are afforded an expansive platform to access and exchange information. In turn, our reliance on such devices has comparatively grown in both personal and business settings.

Given the widespread use of such devices, it is not uncommon for a user to utilize a hands-free device when operating a consumer device. Typically, a hands-free device may include one or more ear-pieces for listening and a mouthpiece/microphone for speaking. While a hands-free device may allow a user to operate a consumer device in a hands-free fashion and provide a semblance of privacy, various situations may arise when the use of a hands-free device can become burdensome for the user. For example, if the consumer device is a mobile phone, and the mobile phone receives an incoming call, a user has to put in one or more earpieces, and locate and press an answer key on the mobile phone. In such situations, a user may be susceptible to missing the incoming call given the multiple steps involved.

### SUMMARY

According to one aspect, a method may include detecting a stimulus based on a sensor of a peripheral device, determining an operative state of a main device, determining whether the operative state of the main device should be adjusted based on the stimulus, and adjusting at least one of the operative state of the main device or the peripheral device if the stimulus indicates a use of the peripheral device by a user.

Additionally, the detecting may include detecting the stimulus based on at least one of a capacitance, an inductance, a pressure, a temperature, an illumination, a movement, or an acoustical parameter associated with an earpiece of the peripheral device.

Additionally, the determining the operative state of the main device may include determining whether the main device is receiving a telephone call.

Additionally, the adjusting may include automatically accepting the telephone call without the main device receiving an accept call input from the user if it is determined that the main device is receiving the telephone call.

Additionally, the method may include adjusting the operative state of the main device if the stimulus indicates a non-use of the peripheral device by the user.

Additionally, the adjusting the operative state of the main device if the stimulus indicates a non-use may include preventing sound from emanating from an earpiece of the peripheral device if auditory information is produced by the main device.

Additionally, the preventing may include preventing sound from emanating from the earpiece by performing at least one of muting the auditory information or pausing an application running on the main device that is producing the auditory information.

Additionally, the method may include determining an operative state of the peripheral device based on a value associated with the stimulus, where the operative state relates to whether the user has one or more earpieces of the peripheral device positioned in a manner corresponding to the user being able to listen to auditory information.

According to another aspect, a device may include a memory to store instructions, and a processor to execute the instructions. The processor may execute the instructions to receive a stimulus based on a sensor of a headset, determine at least one of whether one or more earpieces of the headset are positioned in a manner corresponding to a user being able to listen to auditory information or whether one or more microphones of the headset are being used by the user, and adjust the operative state of the device if the stimulus indicates the one or more earpieces are positioned in the manner corresponding to the user being able to listen to auditory information.

Additionally, the stimulus may include a value and the value of the stimulus may be based on at least one of a capacitance, an inductance, a pressure, a temperature, light, a movement, or an acoustical impedance and phase, and the value of the stimulus may correspond to the one or more earpieces positioned in the manner corresponding to the user being able to listen to auditory information or the one or more earpieces positioned in a manner corresponding to the user not being able to listen to auditory information.

Additionally, the processor may further execute instructions to receive an incoming telephone call, and where the instructions to adjust may include instructions to automatically accept the incoming telephone call without receiving an accept call input from the user.

Additionally, the processor may further execute instructions to adjust the operative state of the device if the stimulus indicates the one or more earpieces are not positioned in a manner corresponding to the user being able to listen to auditory information.

According to still another aspect, a headset may include one or more earpieces, where each earpiece of the one or more earpieces may include a sensor to detect a capacitance value, and where auditory information may be prevented from emanating from each earpiece if the capacitance value does not correspond to a capacitance value that indicates a user is utilizing a respective earpiece of the one or more earpieces to receive auditory information.

Additionally, the headset may include one or more microphones.

Additionally, the one or more microphones may include a plurality of microphones, and the one or more earpieces may include a plurality of earpieces, and each microphone of the plurality of microphones may be associated with one of the plurality of earpieces, and each microphone of the plurality of microphones may be configured to be disabled if the detected capacitance value does not correspond to a threshold value.

Additionally, the headset may include a wireless headset.

According to yet another aspect, a computer-readable medium containing instructions executable by at least one processor of a device, the computer-readable medium may include one or more instructions for receiving a stimulus from a peripheral device that includes a sensor, one or more instructions for determining whether the stimulus indicates whether a user is using the peripheral device, and one or more instructions for altering an operation of the device if the stimulus indicates that the user is using the peripheral device.

Additionally, where the stimulus value relates to at least one of a capacitance, an inductance, a pressure, a temperature, light, a movement, or an acoustical parameter.

Additionally, the computer-readable medium may include one or more instructions establishing a wireless connection with the peripheral device, whether the peripheral device is a headset, and one or more instructions for altering the operation of the device if the stimulus indicates that the user is not using the headset.

Additionally, where the stimulus may include a first stimulus value and a second stimulus value, and the computer-readable medium may further include one or more instructions for muting auditory information emanating from a first earpiece of the headset if the first stimulus value indicates that the user does not have the first earpiece contacting the user's ear, and allowing auditory information to emanate from a second earpiece of the headset if the second stimulus value indicates that the user does have the second earpiece contacting the user's ear.

Additionally, the computer-readable medium may include one or more instructions for pausing a media player of the device if the first stimulus value associated with the first earpiece and the second stimulus value associated with the second earpiece indicate that the user is not using either the first earpiece or the second earpiece.

### BRIEF DESCRIPTION OF THE DRAWINGS

The accompanying drawings, which are incorporated in and constitute a part of this specification, illustrate exemplary embodiments described herein and, together with the description, explain these exemplary embodiments. In the drawings:

FIGS. 1A and 1B are diagrams illustrating concepts described herein;

FIG. 2 is a diagram illustrating a front view of exemplary external components of an exemplary device;

FIG. 3 is a diagram illustrating a side view of exemplary external components of the exemplary device depicted in FIG. 2;

FIG. 4 is a diagram illustrating exemplary internal components that may correspond to the device depicted in FIG. 2;

FIG. 5 is a diagram illustrating exemplary components of an exemplary hands-free device;

FIG. 6 is a flow chart illustrating an exemplary process for performing operations that may be associated with the concepts described herein; and

FIGS. 7A and 7B are diagrams illustrating an example of the concepts described herein.

### DETAILED DESCRIPTION

The following detailed description refers to the accompanying drawings. The same reference numbers in different drawings may identify the same or similar elements. Also, the following description does not limit the invention.

### Overview

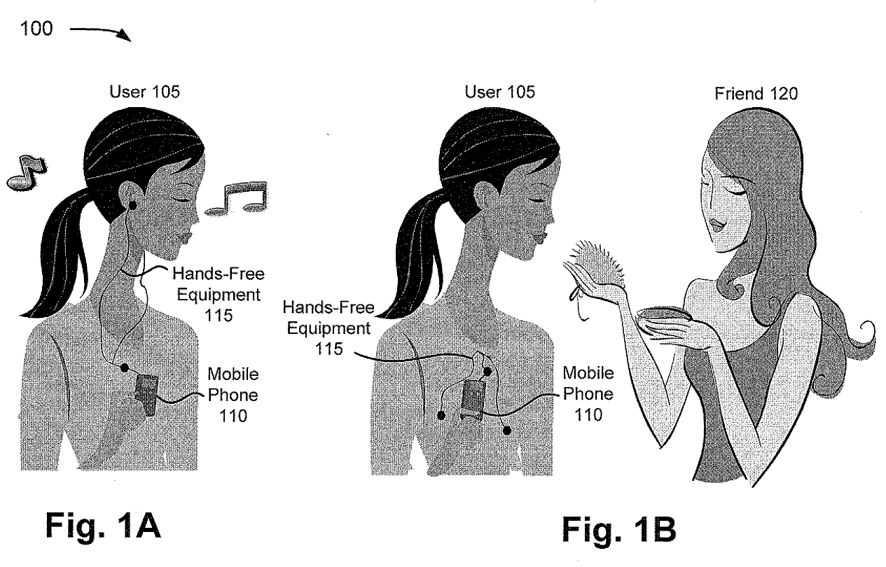

FIGS. 1A and 1B are diagrams illustrating concepts as described herein. As illustrated in FIG. 1A of an environment 100, a user 105 may be operating a consumer device, such as a mobile phone 110. Mobile phone 110 may include a digital audio player (DAP). In this instance, user 105 may be using hands-free device 115 to listen to music on the DAP.

Shortly thereafter, as illustrated in FIG. 1B, a friend 120 approaches user 105 wanting to show her some new items that she recently purchased. In this instance, user 105 may remove the earpieces from her ears. However, user 105 does not have to turn off the DAP and/or turn down the volume to speak to friend 120 so as to avoid the distraction caused by the music emanating from the earpieces. Rather, the music playing may be automatically muted, paused, and/or stopped based on user 105 removing the earpieces. In one implementation, the earpieces may include a sensor to detect if the earpieces are inserted into user's 105 ears.

As a result of the foregoing, a user's operation of a consumer device and hands-free device may be less burdensome. The concepts described herein have been broadly described in connection with FIGS. 1A and 1B. Accordingly, a detailed description and variations are provided below.

### Exemplary Device

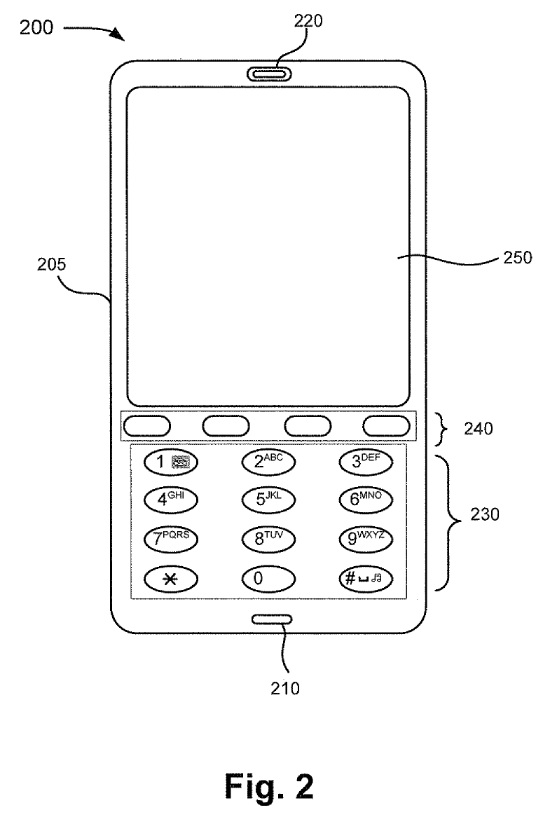

FIG. 2 is a diagram illustrating a front view of exemplary external components of an exemplary device 200. As illustrated, device 200 may include a housing 205, a microphone 210, a speaker 220, a keypad 230, function keys 240, and/or a display 250. The term “component,” as used herein, is intended to be broadly interpreted to include hardware, software, and/or a combination of hardware and software.

Housing 205 may include a structure to contain components of device 200. For example, housing 205 may be formed from plastic or metal and may support microphone 210, speaker 220, keypad 230, function keys 240, and display 250.

Microphone 210 may include any component capable of transducing air pressure waves to a corresponding electrical signal. For example, a user may speak into microphone 210 during a telephone call. Speaker 220 may include any component capable of transducing an electrical signal to a corresponding sound wave. For example, a user may listen to music or listen to a calling party through speaker 220.

Keypad 230 may include any component capable of providing input to device 200. Keypad 230 may include a standard telephone keypad. Keypad 230 may also include one or more special purpose keys. In one implementation, each key of keypad 230 may be, for example, a pushbutton. A user may utilize keypad 230 for entering information, such as text or a phone number, or activating a special function.

Function keys 240 may include any component capable of providing input to device 200. Function keys 240 may include a key that permits a user to cause device 200 to perform one or more operations. The functionality associated with a key of function keys 240 may change depending on the mode of device 200. For example, function keys 240 may perform a variety of operations, such as placing a telephone call, playing various media (e.g., music, videos), sending e-mail, setting various camera features (e.g., focus, zoom, etc.) and/or accessing an application. Function keys 240 may include a key that provides a cursor function and a select function. In one implementation, each key of function keys 240 may be, for example, a pushbutton.

Display 250 may include any component capable of providing visual information. For example, in one implementation, display 250 may be a liquid crystal display (LCD). In another implementation, display 250 may be any one of other display technologies, such as a plasma display panel (PDP), a field emission display (FED), a thin film transistor (TFT) display, etc. Display 250 may display, for example, text, image, and/or video information to a user.

Device 200 is intended to be broadly interpreted to include any number of devices that may operate in cooperation with a peripheral device, such as a hands-free device. For example, device 200 may include a portable device, such as a wireless telephone, a PDA, an audio player, an audio/video player, an MP3 player, a gaming device, a computer, or another kind of communication, computational, and/or entertainment device. In other instances, device 200 may include a stationary device, such as an audio player, an audio/video player, a gaming device, a computer, or another kind of communication, computational, and/or entertainment device. Still further, device 200 may include a communication, computational, and/or entertainment device in an automobile, in an airplane, etc. Accordingly, although FIG. 2 illustrates exemplary external components of device 200, in other implementations, device 200 may contain fewer, different, or additional external components than the external components depicted in FIG. 2. Additionally, or alternatively, one or more external components of device 200 may perform the functions of one or more other external components of device 200. For example, display 250 may be an input component (e.g., a touch screen). Additionally, or alternatively, the external components may be arranged differently than the external components depicted in FIG. 2.

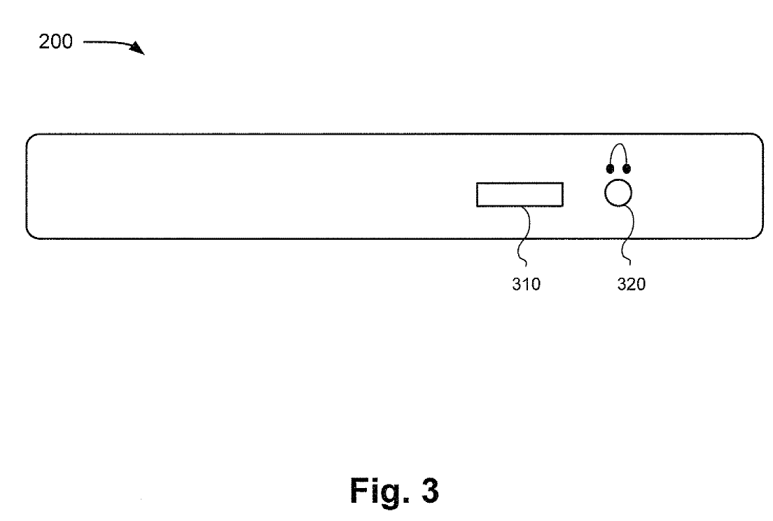

FIG. 3 is a diagram illustrating a side view of exemplary external components of device 200. As illustrated, device 200 may include a universal serial bus (USB) port 310 and a hands-free device (HFD) port 320.

USB port 310 may include an interface, such as a port (e.g., Type A), that is based on a USB standard (e.g., version 1.2, version 2.0). Device 200 may connect to and/or communicate with other USB devices via USB port 310. Hands-free device port 320 may include an interface, such as a port (e.g., a headphone and/or microphone jack), that provides a connection to and/or communication with a hands-free device.

Although FIG. 3 illustrates exemplary external components of device 200, in other implementations, device 200 may contain fewer, different, or additional external components than the external components depicted in FIG. 3. For example, device 200 may include an infrared port and/or another type of port to connect with another device.

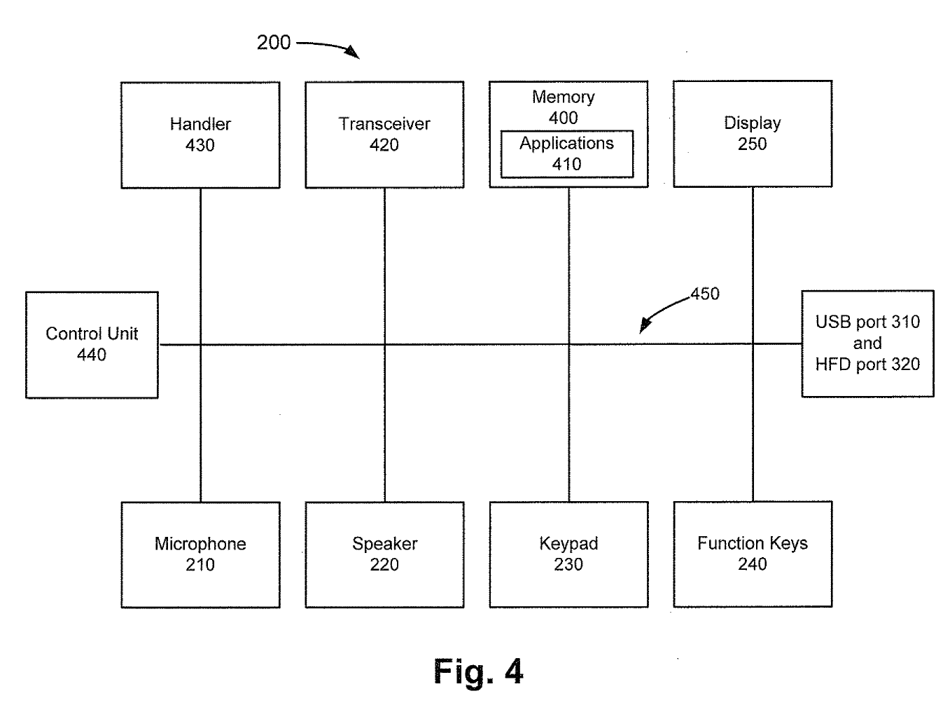

FIG. 4 is a diagram illustrating exemplary internal components of device 200 depicted in FIG. 2. As illustrated, device 200 may include microphone 210, speaker 220, keypad 230, function keys 240, display 250, USB port 310, HFD port 320, a memory 400 (with applications 410), a transceiver 420, a handler 430, a control unit 440, and a bus 450. Microphone 210, speaker 220, keypad 230, function keys 240, display 250, USB port 310, and HFD port 320 may include the features and/or capabilities described above in connection with FIG. 2 and FIG. 3.

Memory 400 may include any type of storing/memory component to store data and instructions related to the operation and use of device 200. For example, memory 400 may include a memory component, such as a random access memory (RAM), a dynamic random access memory (DRAM), a static random access memory (SRAM), a synchronous dynamic random access memory (SRAM), a ferroelectric random access memory (FRAM), a read only memory (ROM), a programmable read only memory (PROM), an erasable programmable read only memory (EPROM), an electrically erasable programmable read only memory (EEPROM), and/or a flash memory. Additionally, memory 400 may include a storage component, such as a magnetic storage component (e.g., a hard disk), a compact disc (CD) drive, a digital versatile disc (DVD), or another type of computer-readable medium, along with their corresponding drive(s). Memory 400 may also include an external storing component, such as a USB memory stick, a memory card, and/or a subscriber identity module (SIM) card.

Memory 400 may include applications 410. Applications 410 may include a variety of software programs, such as a telephone directory, camera, a DAP, a digital media player (DMP), an organizer, a text messenger, a web browser, a calendar, games, etc.

Transceiver 420 may include any component capable of transmitting and receiving data. For example, transceiver 420 may include a radio circuit that provides wireless communication with a network or another device. Transceiver 420 may support communication protocols and/or standards.

Handler 430 may include a component capable of performing one or more operations associated with the concepts described herein. For example, handler 430 may make a determination associated with the operation of device 200 based on one or more sensors of a hands-free device. Handler 430 will be described in greater detail below.

Control unit 440 may include any logic that interprets and executes instructions to control the overall operation of device 200. Logic, as used herein, may include hardware, software, and/or a combination of hardware and software. Control unit 440 may include, for example, a general-purpose processor, a microprocessor, a data processor, a co-processor, a network processor, an application specific integrated circuit (ASIC), a controller, a programmable logic device, a chipset, and/or a field programmable gate array (FPGA). Control unit 440 may access instructions from memory 400, from other components of device 200, and/or from a source external to device 200 (e.g., a network or another device). Control unit 440 may provide for different operational modes associated with device 200. Additionally, control unit 440 may operate in multiple operational modes simultaneously. For example, control unit 440 may operate in a camera mode, a music playing mode, a radio mode (e.g., amplitude modulation/frequency modulation (AM/FM)), and/or a telephone mode.

Bus 450 may include one or more communication paths that allow communication among the components of device 200. Bus 450 may include, for example, a system bus, an address bus, a data bus, and/or a control bus. Bus 450 may include bus drivers, bus arbiters, bus interfaces and/or clocks.

Device 200 may perform certain operations relating to handler 430. Device 200 may perform these operations in response to control unit 440 executing software instructions contained in a computer-readable medium, such as memory 400. A computer-readable medium may be defined as a physical or logical memory device. The software instructions may be read into memory 400 and may cause control unit 440 to perform processes associated with handler 430. Alternatively, hardwired circuitry may be used in place of or in combination with software instructions to implement processes described herein. Thus, implementations described herein are not limited to any specific combination of hardware circuitry and software.

Although FIG. 4 illustrates exemplary internal components, in other implementations, fewer, additional, and/or different internal components than the internal components depicted in FIG. 4 may be employed. For example, one or more internal components of device 200 may include the capabilities of one or more other components of device 200. For example, transceiver 420 and/or control unit 440 may include their own on-board memory 400. Additionally, or alternatively, device 200 may not include microphone 210, transceiver 420, and/or function keys 240. Additionally, or alternatively, the functionality described herein associated with handler 430 may be partially and/or fully employed by one or more other components, such as control unit 440 and/or applications 410. Additionally, or alternatively, the functionality associated with handler 430 may be partially and/or fully employed by one or more components of hands-free device 500.

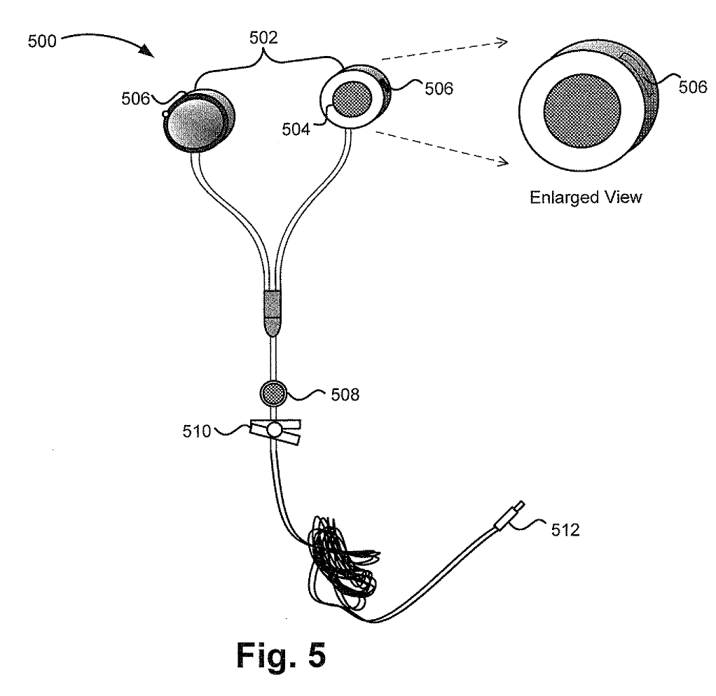

FIG. 5 is a diagram illustrating exemplary components of an exemplary hands-free device 500. As illustrated, hands-free device 500 may include earpieces 502, speakers 504, sensors 506, a microphone 508, a clip 510, and a connector 512.

Earpieces 502 may include a housing to include one or more components. The housing may include, for example, plastic or metal, and may have an oval shape or another shape. For example, the size and shape of earpieces 502 may determine how a user uses earpieces 502. That is, an in-ear earpiece may be formed to be inserted into a user's ear canal. Alternatively, an in-concha earpiece may be formed to be inserted into the concha portion of a user's ear. Alternatively, a supra-aural earpiece or a circulum-aural earpiece may be formed to be worn on an outer portion of a user ear (e.g., cover a portion of the outer ear or the entire ear). Earpieces 502 may include speakers 504. Speakers 504 may include a component corresponding to that previously described above with reference to speaker 220.

Sensors 506 may include a component capable of detecting one or more stimuli. For example, sensors 506 may detect capacitance, inductance, pressure, temperature, light, movement, and/or an acoustic variable (e.g., acoustic impedance, phase shift, etc.). In one implementation sensors 506 may detect capacitance, impedance, pressure, temperature, light, movement, and/or acoustical impedance and phase associated with a user's proximity, touch (e.g., a user's ear), and/or movement of earpiece 502 to or from the user's ear. Additionally, sensors 506 may detect capacitance, inductance, pressure, temperature, light, movement, and/or acoustical impedance and phase based on ambient conditions. Thus, sensors 506 may detect changes in one or more of these exemplary parameters. Further, sensors 506 may generate an output signal corresponding to a user's proximity, a user's touch, a user's non-proximity, and/or a user's non-touch. In this regard, discriminating between if a user is utilizing earpieces 502 for listening to auditory information (e.g., having earpieces 502 properly positioned to permit a user to listen to music, a telephone conversation, etc.) and if a user is not utilizing earpieces 502 for listening to auditory information should be detected by sensors 506. As will be described later, the output signal may be used to perform one or more operations associated with the concepts described herein.

In one implementation, if sensors 506 detect capacitance based on a user's touch (e.g., a user's ear), sensors 506 may include a contact region. The contact region may include plastic or some other material to protect the underlying sensors 506 from dirt, dust, etc. Sensor 506 may include a transmitter and a receiver. The transmitter and the receiver may include metal and may be connected to, for example, a printed circuit board (PCB). When the contact region is touched, the PCB may convert the detected capacitance to a digital signal. The PCB may generate an output signal to device 200. In other instances, if the contact region is not touched, the PCB may convert the detected capacitance to a digital signal that may be output to device 200. Device 200 may determine whether the contact region is touched or not based on the values of the digital signals corresponding to the detected capacitances.

Additionally, or alternatively, sensors 506 may detect inductance based on a user's touch (e.g., a user's ear). For example, sensors 506 may include a contact region. The contact region may include plastic or some other material to protect the underlying sensors 506 from dirt, dust, etc. Sensor 506 may include a transmitter and a receiver. The transmitter and the receiver may include metal and may be connected to, for example, a printed circuit board (PCB). When the contact region is touched, the PCB may convert the detected inductance to a digital signal. The PCB may generate an output signal to device 200. In other instances, if the contact region is not touched, the PCB may convert the detected inductance to a digital signal that may be output to device 200. Device 200 may determine whether the contact region is touched or not based on the values of the digital signals corresponding to the detected inductances.

Additionally, or alternatively, sensors 506 may include a pressure-sensor. For example, the pressure sensor may include a pressure-sensitive surface, such as a pressure-sensitive film. The pressure-sensitive film may include, for example, a conductive layer and a resistive layer. If pressure is exerted on the pressure-sensitive film, electrical contact may be made to produce an output voltage(s). Similarly, sensors 506 may output a signal to device 200. Device 200 may determine whether the contact region is touched or not touched based on the value of the output voltage and/or the absence thereof.

Additionally, or alternatively, sensors 506 may include a temperature sensor. The temperature sensor may generate an output voltage(s) if the detected temperature corresponds to a threshold temperature value (e.g., that equivalent to a human body). Similarly, sensors 506 may output a signal to device 200. Device 200 may determine whether the temperature value corresponds to that of a human body or air temperature.

Additionally, or alternatively, sensors 506 may include a photodetector. The photodetector may generate an output voltage(s) corresponding to an illumination value to device 200. Device 200 may determine whether the illumination value corresponds to that of earpiece(s) 502 being proximate to a user's ear, touching a user's ear, inside of a user's ear, etc.

Additionally, or alternatively, sensors 506 may include an accelerometer. The accelerometer may generate an output voltage corresponding to an acceleration value to device 200. Device 200 may determine whether the acceleration value corresponds to that of earpiece(s) 502 being moved (e.g., being placed into a user's ear, on a user's ear, etc.)

Additionally, or alternatively, sensors 506 may include an acoustic sensor. The acoustic sensor may generate an output voltage corresponding to an acoustic value (e.g., an acoustic impedance, phase) to device 200. Device 200 may determine whether the acoustic value corresponds to that of earpiece(s) 502 being proximate to a user's ear, touching a user's ear, inside of a user's ear, etc.

Microphone 508 may include a component corresponding to that previously described above with respect to microphone 210. Clip 510 may include a mechanism for clasping a portion of hands-free device 500 to a user's attire. For example, clip 510 may include a mechanism similar to an alligator clip. Connector 512 may include a plug for connecting hands-free device 500 to device 200. For example, connector 512 may be inserted into HFD port 320.

Although FIG. 5 illustrates exemplary components, in other implementations, fewer, additional, and/or different components than those described in relation to FIG. 5 may be employed. For example, hands-free device 500 may include a single earpiece 502 and/or hands-free device 500 may include two microphones 508. Additionally, or alternatively, hands-free device 500 may not include clip 510, microphone 508, and/or connector 512. Additionally, or alternatively, hands-free device 500 may include an additional component to interpret signals output by sensors 506 and/or perform various operations associated with the concepts described herein in relation to device 200.

Additionally, or alternatively, hands-free device 500 may be a wireless device (e.g., a Bluetooth-enabled device). Additionally, or alternatively, hands-free device 500 may include, for example, one or more buttons (e.g., an on/off button, a volume control button, a call/end button), a miniature display, and/or other components to perform, for example, digital echo reduction, noise cancellation, auto pairing, voice activation, etc.

Additionally, or alternatively, sensors 506 may be arranged differently and/or the number thereof with respect to earpieces 502 may be different than the arrangement and/or the number of sensors 506 illustrated in FIG. 5. For example, depending on the type of earpiece (e.g., in-ear, in-concha, supra-aural, or circulum aural) sensors 506 may be positioned differently than the position of sensors 506 depicted in FIG. 5. In this regard, sensors 506 may be arranged to detect instances when a user is using earpieces 502 in a manner that corresponds to the user listening to auditory information. For example, if sensors 506 detect capacitance, hands-free device 500 and/or device 200 should be able to discriminate between touching, for example, a user's bare-chest, versus, for example, a user's ear. In one implementation, the position, arrangement, and/or number of sensors 506 may minimize a false positive reading (i.e., to discriminate if a user has positioned earpieces 502 for listening or not). Additionally, or alternatively, sensors 506 may detect more than one parameter in order to minimize false positives. Additionally, or alternatively, since sensors 506 may detect any parameter that could be associated with a user's use of hands-free device 500 or non-use of hands-free device 500, parameters other than capacitance, inductance, pressure, temperature, light, movement, and/or acoustical impedance and phase may be employed. Accordingly, hands-free device 500 is intended to be broadly interpreted as a peripheral device that may include one or more user interfaces (UIs) (e.g., an auditory interface and/or a visual interface) to a main device, such as device 200.

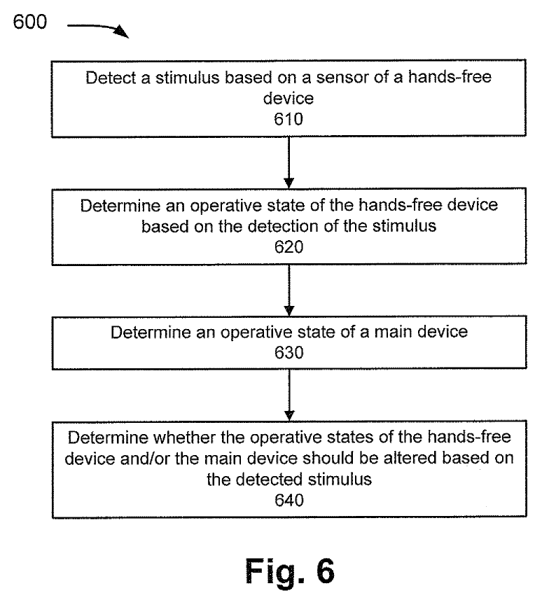

FIG. 6 is a flow chart illustrating an exemplary process 600 for performing operations that may be associated with the concepts described herein. Process 600 may begin with detecting a stimulus based on a sensor of a hands-free device (Block 610). For example, sensors 506 of hands-free device 500 may detect a stimulus corresponding to one or more parameters (e.g., capacitance, inductance, pressure, temperature, etc.) based on a user inserting earpieces 502 into his/her ear or touching earpieces 502. Conversely, sensors 506 of hands-free device 500 may detect a stimulus corresponding to one or more parameters (e.g., capacitance, inductance, pressure, temperature, etc.) based on a user not inserting earpieces 502 into his/her ear or touching earpieces 502.

Determine an operative state of the hands-free device based on the detection of the stimulus (Block 620). For example, the operative state may correspond to whether one or more earpieces 502 are inserted into a user's ear. In other instances, the operative state may correspond to one or more earpieces 502 touching a user's outer ear. In instances when hands-free device 500 includes two earpieces 502 and one earpiece 502 is inserted into or touching a user's ear, while the other earpiece 502 is not, one of sensors 506 may detect a stimulus different than the other sensor 506.

Determine an operative state of a main device (Block 630). For example, handler 430 of device 200 may identify an application 410 that is running (e.g., a DAP, a DMP, a web browser, an audio conferencing application (e.g., an instant messaging program)), whether device 200 is receiving an incoming telephone call, whether device 200 is placing an outgoing telephone call (with or without voice dialing), whether device 200 is in the midst of a telephone call, whether device 200 is operating in a radio mode (e.g., receiving an AM or FM station), whether device 200 is in a game mode, and/or another operative state that device 200 may be operating. In this way, handler 430 may identify an operative state of device 200 that may have a relationship to the use and functionality associated with hands-free device 500.

Determine whether the operative states of the hands-free device and/or the main device should be altered based on the detected stimulus (Block 640). For example, in an instance when handler 430 determines that the operative state of device 200 corresponds to device 200 receiving an incoming telephone call, and handler 430 determines a change of an operative state of hands-free device 500 based on sensors 506 (e.g., sensors 506 detect a stimulus corresponding to a user inserting earpieces 502 into his/her ear), handler 430 may automatically accept the incoming telephone call without a user, for example, having to press a button (e.g., a key of function keys 240, a key of keypad 230, etc.) on device 200 to accept the incoming telephone call. That is, the user inserting earpieces 502 into his/her ears (subsequent to device 200 receiving the incoming telephone call) provides indication to handler 430 of the user's intention to accept the incoming telephone call.

Additionally, if hands-free device 500 includes two earpieces 502, yet handler 430 determines that only one of the two earpieces 502 is inserted into the user's ears, then the audio associated with the incoming telephone call may be supplied to earpiece 502 that is inserted into the user's ear. That is, earpiece 502 that is not inserted into the user's ear may be automatically muted and/or receive no audio signal from device 200. As a result, a privacy factor associated with audio (e.g., a telephone call) may be maintained. Additionally, if earpiece 502 is re-inserted into the user's ear, audio to earpiece 502 may be automatically un-muted and/or receive an audio signal.

Instances similar to the above may be envisioned in which handler 430 and/or control unit 440 interact with hands-free device 500 to enhance the user's experience with respect to operating device 200. For example, if device 200 is playing music and/or a video, and a user also takes earpieces 502 from his/her ears, the music and/or video may be automatically paused, muted, or stopped. For example, handler 430 may pause application 410 (e.g., a DAP or a DMP), mute the audio, or stop the DAP or the DMP. Additionally, if hands-free device 500 includes two earpieces 502, yet handler 430 determines that only one of the two earpieces 502 is inserted into the user's ear, earpiece 502 that is not inserted into the user's ear may be automatically muted and/or not receive an audio signal, while earpiece 502 this is inserted into the user's ear may continue to receive audio. Additionally, if earpiece 502 is re-inserted into the user's ear, audio may be automatically un-muted and/or an audio signal may be automatically provided to earpiece 502.

In another instance, assume that hands-free device 500 includes two microphones 508. If one microphone is associated with an earpiece 502 that is not inserted into a user's ear, then hands-free device 500 may not only mute and/or not send an audio signal to that earpiece 502, but also may automatically mute microphone 508 and/or not permit audio signals from microphone 508 from being input to device 200. For example, if microphone 508 is dangling and not being used, the noise generated by microphone 508 may be distracting to a user. In this regard, muting microphone 508 may be beneficial to a user's experience.

In other situations, if earpiece(s) 502 includes a button or other input/output mechanism and such earpiece(s) 502 is not inserted into a user's ear, the button or other mechanism may be disabled.

Although not specifically described, numerous situations may be envisioned with respect to the user of hands-free device 500 and applications executed by device 200. For example, depending on applications 410 running (e.g., that may produce audio information) and/or the state of device 200, auditory signals sent to earpiece(s) not inserted into a user's ear may be, for example, muted or not sent, based on sensors 506. Additionally, or alternatively, if one of applications 410 is running, and subsequent thereto, a user removes all earpieces 502, application 410 may pause or stop.

Although FIG. 6 illustrates an exemplary process, in other implementations, fewer, additional or different operations than those depicted in FIG. 6 may be performed. For example, device 200 and/or hands-free device 500 may include a user interface (UI) that permits a user to select what actions may be automatically performed (e.g., stopping a media player, a game, etc., or answering a call) based on earpiece(s) 502 being inserted and/or touching the user's ear.

### EXAMPLE

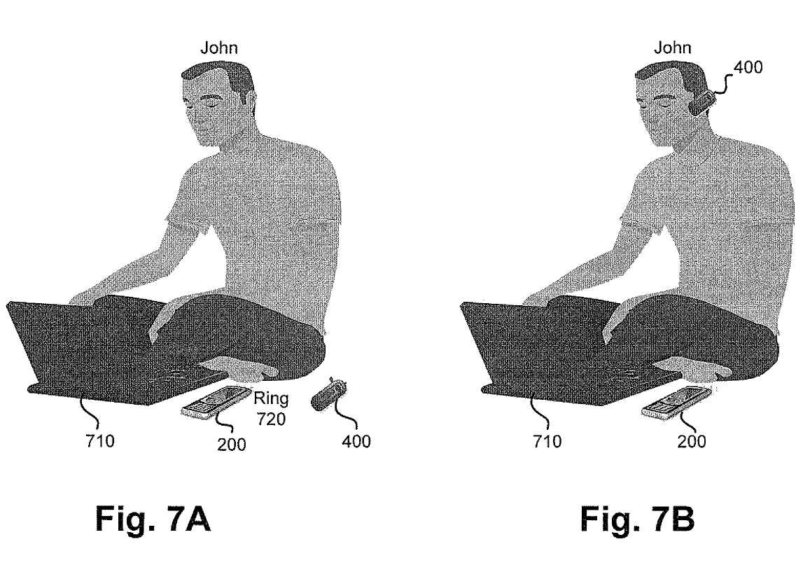

FIGS. 7A and 7B are diagrams illustrating an example of the concepts described herein. For purposes of discussion, assume that John is working from home on his laptop computer 710 with device 200, such as a mobile phone, and hands-free device 400, such as a Bluetooth-enabled device. As illustrated in FIG. 7A, while John is working, device 200 receives an incoming telephone call and device 200 rings (i.e., ring 720). In FIG. 7B, John answers the telephone call by placing earpiece 502 into his ear. For example, sensor 506 detects that earpiece 502 of hands-free device 500 is in John's ear and outputs a signal to handler 430. Handler 430 may cause device 200 to answer the incoming telephone call without John having to press a key (e.g., a key of keypad 230 or a key of function keys 240) on device 200. Thereafter, John may begin a conversation with the calling party via hands-free device 400.

### CONCLUSION

The foregoing description of implementations provides illustration, but is not intended to be exhaustive or to limit the implementations to the precise form disclosed. Modifications and variations are possible in light of the above teachings or may be acquired from practice of the teachings. For example, if hands-free device 500 is a Bluetooth enabled device that is turned on, but is in sleep-mode to save power, hands-free device 500 may automatically connect with device 200 based on a user putting earpiece 502 into the user's ear. Additionally, the functionality and corresponding components associated with the concepts described herein with respect to device 200 and hands-free device 500 may different. For example, handler 430 may be a component of hands-free device 500. Thus, the functions, operations, signaling, etc. associated with the concepts described herein may be performed by one or more components located in device 200 and/or hands-free device 500. For example, hands-free device 500 may include a module with a processor to interpret signals from sensors 506 and convert the sensor signals to a communication protocol to command device 200 to perform one or more operations in accordance with the interpreted sensor signals.

Additionally, or alternatively, hands-free device 500 may indicate (e.g., by light emitting diodes) that auditory information is being received by earpieces 502. Additionally, or alternatively, different visual cues may be generated depending on the type of auditory information being received (e.g., music or telephone conversation), which may be beneficial to a third party who may or may not wish to interrupt the user.

It should be emphasized that the term “comprises” or “comprising” when used in the specification is taken to specify the presence of stated features, integers, steps, or components but does not preclude the presence or addition of one or more other features, integers, steps, components, or groups thereof.

In addition, while a series of blocks has been described with regard to processes illustrated in FIG. 6, the order of the blocks may be modified in other implementations. Further, non-dependent blocks may be performed in parallel. Further one or more blocks may be omitted.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential to the implementations described herein unless explicitly described as such. Also, as used herein, the article “a” and “an” are intended to include one or more items. Where only one item is intended, the term “one” or similar language is used. Further, the phrase “based on” is intended to mean “based, at least in part, on” unless explicitly stated otherwise. As used herein, the term “and/or” includes any and all combinations of one or more of the associated list items.

What is claimed is:

1. A method, comprising:
detecting a stimulus based on a sensor of a peripheral device;
determining an operative state of a main device;
determining whether the operative state of the main device should be adjusted based on the stimulus; and
adjusting at least one of the operative state of the main device or the peripheral device if the stimulus indicates a use of the peripheral device by a user.

2. The method of claim 1, where the detecting comprises:
detecting the stimulus based on at least one of a capacitance, an inductance, a pressure, a temperature, an illumination, a movement, or an acoustical parameter associated with an earpiece of the peripheral device.

3. The method of claim 1, where the determining the operative state of the main device comprises:
determining whether the main device is receiving a telephone call.

4. The method of claim 3, where the adjusting comprises:
automatically accepting the telephone call without the main device receiving an accept call input from the user if it is determined that the main device is receiving the telephone call.

5. The method of claim 1, further comprising:
adjusting the operative state of the main device if the stimulus indicates a non-use of the peripheral device by the user.

6. The method of claim 5, where the adjusting the operative state of the main device if the stimulus indicates a non-use further comprises:
preventing sound from emanating from an earpiece of the peripheral device if auditory information is produced by the main device.

7. The method of claim 6, where the preventing comprises:
preventing sound from emanating from the earpiece by performing at least one of muting the auditory information or pausing an application running on the main device that is producing the auditory information.

8. The method of claim 1, further comprising:
determining an operative state of the peripheral device based on a value associated with the stimulus, where the operative state relates to whether the user has one or more earpieces of the peripheral device positioned in a manner corresponding to the user being able to listen to auditory information.

9. A device comprising:
a memory to store instructions; and
a processor to execute the instructions to:
receive a stimulus based on a sensor of a headset,
determine at least one of whether one or more earpieces of the headset are positioned in a manner corresponding to a user being able to listen to auditory information or whether one or more microphones of the headset are being used by the user, and
adjust the operative state of the device if the stimulus indicates the one or more earpieces are positioned in the manner corresponding to the user being able to listen to auditory information.

10. The device of claim 9, where the stimulus comprises a value and the value of the stimulus is based on at least one of a capacitance, an inductance, a pressure, a temperature, light, a movement, or an acoustical impedance and phase, and the value of the stimulus corresponds to the one or more earpieces positioned in the manner corresponding to the user being able to listen to auditory information or the one or more earpieces positioned in a manner corresponding to the user not being able to listen to auditory information.

11. The device of claim 9, where the processor further executes instructions to:
receive an incoming telephone call, and where the instructions to adjust comprise instructions to automatically accept the incoming telephone call without receiving an accept call input from the user.

12. The device of claim 9, where the processor further executes instructions to:
adjust the operative state of the device if the stimulus indicates the one or more earpieces are not positioned in a manner corresponding to the user being able to listen to auditory information.

13. A headset, comprising:
one or more earpieces, where each earpiece of the one or more earpieces includes a sensor to detect a capacitance value, and
where auditory information is prevented from emanating from each earpiece if the capacitance value does not correspond to a capacitance value that indicates a user is utilizing a respective earpiece of the one or more earpieces to receive auditory information.

14. The headset of claim 13, further comprising:
one or more microphones.

15. The headset of claim 14, where the one or more microphones includes a plurality of microphones and the one or more earpieces includes a plurality of earpieces, each microphone of the plurality of microphones being associated with one of the plurality of earpieces, and each microphone of the plurality of microphones is configured to be disabled if the capacitance value does not correspond to a threshold capacitance value.

16. The device of claim 13, wherein the headset is a wireless headset.

17. A computer-readable medium containing instructions executable by at least one processor of a device, the computer-readable medium comprising:
one or more instructions for receiving a stimulus from a peripheral device that includes a sensor;
one or more instructions for determining whether the stimulus indicates whether a user is using the peripheral device; and
one or more instructions for altering an operation of the device if the stimulus indicates that the user is using the peripheral device.

18. The computer-readable medium of claim 17, where the stimulus relates to at least one of a capacitance, an inductance, a pressure, a temperature, light, a movement, or an acoustical parameter.

19. The computer-readable medium of claim 17, further comprising:
one or more instructions for establishing a wireless connection with the peripheral device, where the peripheral device is a headset; and
one or more instructions for altering the operation of the device if the stimulus value indicates that the user is not using the headset.

20. The computer-readable medium of claim 17, where the stimulus includes a first stimulus value and a second stimulus value, the computer-readable medium further comprising:
one or more instructions for muting auditory information emanating from a first earpiece of the headset if the first stimulus value indicates that the user does not have the first earpiece contacting the user's ear, and allowing auditory information to emanate from a second earpiece of the headset if the second stimulus value indicates that the user does have the second earpiece contacting the user's ear.

21. The computer-readable medium of claim 20, further comprising:
one or more instructions for pausing a media player of the device if the first stimulus value associated with the first earpiece and the second stimulus value associated with the second earpiece indicate that the user is not using either the first earpiece or the second earpiece.
